(19) United States
(12) Patent Application Publication
(10) Pub. No.: US 2025/0244298 A1
(43) Pub. Date: Jul. 31, 2025

(54) ACUTE AORTIC DISSECTION PLASMA BIOMARKER AND USE THEREOF

(71) Applicant: NANJING MEDICAL UNIVERSITY, Nanjing, Jiangsu (CN)

(72) Inventors: Aihua GU, Nanjing (CN); Qingguo LI, Nanjing (CN); Qian LIU, Nanjing (CN); Jing JIN, Nanjing (CN); Jin XU, Nanjing (CN); Yong ZHOU, Nanjing (CN)

(73) Assignee: NANJING MEDICAL UNIVERSITY, Nanjing, Jiangsu (CN)

(21) Appl. No.: 18/854,211

(22) PCT Filed: Dec. 5, 2023
(86) PCT No.: PCT/CN2023/136534

§ 371 Date: Oct. 4, 2024

(30) Foreign Application Priority Data
Dec. 5, 2022 (CN) 202211546165.X

(51) Int. Cl. G01N 30/72; B01D 15/26; B01D 15/42; G01N 30/60

(52) U.S. Cl. CPC G01N 30/7233; B01D 15/265; B01D 15/426; G01N 30/6052

(57) ABSTRACT

There is a significant difference in the expression level of the metabolic molecule isopentenylenine-7-N-glucoside in a patient with acute aortic dissection (AAD) compared to a healthy population. Therefore, a method for predicting acute aortic dissection in a patient includes quantitatively detecting isopentenyladenine-7-N-glucoside in a plasma sample from the patient. Additionally, a reagent for detecting isopentenyladenine-7-N-glucoside, and an acute aortic dissection auxiliary diagnostic kit that includes this reagent, can be used for screening and diagnosing AAD.

### TECHNICAL FIELD

The present invention relates to the field of biomedicines, and particularly to a specific plasma metabolic marker for acute aortic dissection and use thereof.

### BACKGROUND

Acute aortic dissection (AAD) is the most destructive aortic disease with an increasing incidence over the world. AAD is characterized in that pulsatile blood enters the tunica media through a tear in the tunica intima, causing the splitting of the aortic wall. Despite of the improved treatment strategies, mortality and morbidity of patients with AAD remain high. According to the records of inpatients from the China Health Insurance Research Association (CHIRA) in 2011, the annual incidence of aortic dissection in China is estimated to be 2.8 cases per 100,000 people, with approximately 48.6% of patients with aortic dissection dying prior to hospital assessment. Moreover, the patients with aortic dissection in China tend to be younger than those in developed countries. There are increasing evidences that aortic dissection becomes more severe in China. In addition, AAD usually does not present clinical symptoms before acute attack. Therefore, the early diagnosis and screening of AAD are of great significance for preventing and treating the disease.

The current method for diagnostic detection of AAD mainly involves the use of imaging tools, mainly including chest CT. However, such a detection method has a time lag and cannot provide a timely prediction of the disease occurrence. Besides, some invasive radiographies cause additional damage to the body. It is generally believed that vascular structural and metabolic disorders are closely related to the occurrence of AAD. Metabonomic phenotypes are very sensitive to subtle variations and change rapidly in response to physiological and pathological stresses. Therefore, the analysis of low-molecular-weight blood metabolites can definitely provide a potential physiological system profile, so as to provide a rapid and reliable new approach for early diagnosis of AAD.

According to previous studies, levels of smooth muscle myosin heavy chain (smMHC), human soluble elastin fragment (sELAF), calponin and soluble ST2 were reported to be significantly higher in the patients with AAD than in healthy people. However, these differential molecules as proteins are not favorable for the technical popularization and have high detection cost, and most of them have limited half-lives. Therefore, new biomarkers are needed for early detection and prevention of AAD. In the present invention, a convenient, low-trauma and low-cost method for the screening and diagnosis of AAD is established with differential metabolic markers in peripheral serum from a group of patients.

### SUMMARY

In view of the shortcomings in the prior art, an object of the present invention is to provide a new acute aortic dissection plasma biomarker.

Another object of the present invention is to provide use of the acute aortic dissection plasma biomarker.

Yet another object of the present invention is to provide use of a reagent for detecting the biomarker.

The objects of the present invention can be achieved by the following technical solutions:

Use of isopentenyladenine-7-N-glucoside in the preparation of an acute aortic dissection auxiliary diagnostic reagent is provided. Isopentenyladenine-7-N-glucoside has a structural formula shown below:

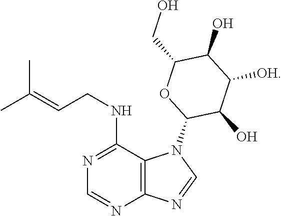 [SMILES: CC(C)=CCNc1ncnc2ncn([C@@H]3O[C@H](CO)[C@@H](O)[C@H](O)[C@H]3O)c12]

Use of a reagent for detecting isopentenyladenine-7-N-glucoside in the preparation of an acute aortic dissection auxiliary diagnostic kit is provided.

In a preferred embodiment of the present invention, the reagent for detecting isopentenyladenine-7-N-glucoside is a reagent for quantitatively detecting isopentenyladenine-7-N-glucoside.

In a further preferred embodiment of the present invention, the reagent for detecting isopentenyladenine-7-N-glucoside is a reagent for quantitatively detecting isopentenyladenine-7-N-glucoside by online solid phase extraction-liquid chromatography-tandem mass spectrometry.

An acute aortic dissection auxiliary diagnostic kit contains:
1) a plasma sample treatment reagent; and
2) a reagent for quantitatively detecting isopentenyladenine-7-N-glucoside, containing an isopentenyladenine-7-N-glucoside standard.

In a preferred embodiment of the present invention, the acute aortic dissection auxiliary diagnostic kit contains:
1) the plasma sample treatment reagent; and
2) the reagent for quantitatively detecting isopentenyladenine-7-N-glucoside by online solid phase extraction-liquid chromatography-tandem mass spectrometry, containing the isopentenyladenine-7-N-glucoside standard.

In a further preferred embodiment of the present invention, the reagent for quantitatively detecting isopropenyladienine-7-N-glucoside by online solid phase extraction-liquid chromatography-tandem mass spectrometry contains:
a) an online solid phase extraction reagent, containing: an HLB SPE column with the specification of 5 μl and 20 mm*3.9 mm; and a mobile phase A: water, a mobile phase B: methanol, and a mobile phase C: acetonitrile; and
b) a liquid chromatography detection reagent, containing: a Poroshell 120 EC-C₁₈ chromatographic column with the specification of 2.7 μl and 2.1 mm*50 mm; and a mobile phase A: 10 mol/L of an ammonium acetate solution containing 0.1% formic acid and a mobile phase B: acetonitrile containing 0.1% formic acid.

### Beneficial Effects

In the present invention, it is found that a metabolic molecule isopentenyladenine-7-N-glucoside having a significant difference between an AAD patient and a healthy population can be used as a biomarker having high specificity and sensitivity for screening and diagnosing acute aortic dissection. According to the use of the metabolic molecule, the metabolic molecule can be used for preparing an AAD auxiliary diagnostic reagent, which provides a convenient, low-trauma and low-cost method for screening and diagnosis of future aortic dissection, and can provide an elective reference basis for accurate diagnosis and timely treatment evaluation of clinical patients.

### BRIEF DESCRIPTION OF THE DRAWINGS

FIG. 1 is an ROC curve showing the result of risk assessment for acute aortic dissection by plasma isopentenyladenine-7-N-glucoside detection.

### DETAILED DESCRIPTION

The technical solutions of the present invention are described below by specific examples, which are only some examples of the present invention, and should not be taken as a limitation on the present invention. Various details in the examples may be appropriately modified without departing from the spirit of the present invention.

### Example 1

### I. Experimental Materials and Methods

### 1.1 Pathological Selection

The study subjects were enrolled from the Second Affiliated Hospital of Nanjing Medical University on January 2017 to April 2019 and included in confirmed cases with acute aortic dissection according to the International Classification of Diseases, Tenth Revision, Clinical Modification (ICD-10-CM) code I71 after obtaining written informed consent. Patients with Marfan syndrome, cancers and connective tissue diseases were excluded. Health controls were a healthy population after physical examination and blood routine examination in the same period. The cases and the control group were matched according to the age and sex and then were detected. The study was approved by the ethical committee and was conducted strictly in accordance with the ethical standards for human experimentation.

### 1.2 Sample Collection

The whole blood samples of the patients were collected in 72 h after attack and the blood samples of the control group were collected at the physical examination center. All the anticoagulated blood samples were allowed to stand at room temperature for 30 min and then centrifuged at 1,000 g for 10 min to obtain the plasma. Then the plasma samples were quickly aliquoted and stored at −80° C. Before detection, the samples were thawed on ice and then centrifuged for 15 min at 3,000 r/min at room temperature, and the upper plasma was taken for detection.

### 1.3 Instruments and Reagents

Methanol and chloroform (CNW Technologies): HPLC grade;
acetonitrile (CAN, Fisher Chemical, USA): Optimal MS grade;
ammonium acetate (purity≥98%, Sigma-Aldrich, USA);
aqueous ammonia (purity 28%-30%, Sigma-Aldrich, USA);
isopentenyladenine-7-N-glucoside (purity 99%, Sigma Aldrich Ltd); and
pure water (from a pure water filter).
1260 online solid phase extraction system;
1260 liquid chromatograph;
6470 triple quadrupole mass spectrometer;
Heraeus Fresco17 centrifuge (Thermo Fisher Scientific);
Forma 900 series ultra-low temperature freezer (Thermo Fisher Scientific);
YM-080S ultrasonic instrument;
DHG-9023 A oven;
LNG-T98 vacuum drier;
electronic balance (Shanghai balance instrument factory); and
full-temperature oscillator (Changzhou Feipu).

### 1.4 Sample Treatment

The plasma sample (100 μl) was taken, added with chloroform:methanol (400 μl, 2:1 (v/v)) and an internal standard, and mixed by rotation, and the mixture was shaken for 20 min. Then the mixture was centrifuged at 13,000 rpm for 20 min at 4° C. to separate the aqueous and organic layer. Subsequently, the supernatant was transferred to a new tube and dried in SpeedVac. After the drying, the organic phase containing lipids was re-dissolved in chloroform:methanol (20 μl, 2:1 (v/v)) and isopropanol:acetonitrile:water (60 μl, 2:1:1 (v/v)). The solution was transferred to a 2 ml sample vial for detection on the instruments. The samples of equal volume were taken (3 μl each), mixed and used as a sample for quality control (QC). The sample for quality control was randomly ranked in the sample detection and injected multiple times, to detect the stability of the instrument and the method.

### 1.5 Detection and Analysis

The metabolite in each sample was analyzed by online solid phase extraction-liquid chromatography-tandem mass spectrometry (XLC/MS/MS). An online solid phase extraction system was connected with a liquid chromatographic separation system by using a ten-way valve, and online enrichment and analysis was performed on the samples by valve switching. With regard to the online solid phase extraction system, an HLB SPE column (5 μl and 20 mm*3.9 mm, Waters Oasis) was used, where a mobile phase A was water, a mobile phase B was methanol, and a mobile phase C was acetonitrile. The specific gradient elution conditions were shown in Table 1. With regard to the chromatographic system, a Poroshell 120 EC-C₁₈ chromatographic column (2.7 μl and 2.1 mm*50 mm) was used, where a mobile phase A was 10 mol/L ammonium acetate solution (containing 0.1% formic acid) and a mobile phase B was acetonitrile (containing 0.1% formic acid); the flow rate was 0.4 mL/min; the column temperature was 40° C.; and the volume of injection was 50 μl. The gradient elution conditions and the ten-way valve switching program were shown in Table 2. With regard to the mass spectrometric system, an electrospray ionization (ESI) source was used; the detection mode was a positive ion mode; the scanning mode was a dynamic multiple reaction monitoring (DMRM) mode; the capillary voltage was 3,500 V, and the nozzle voltage was 500 V; the temperature of nitrogen was 250° C. and the temperature of the drying gas was 300° C.; the flow rate of ammonia was 12 mL/min and the flow rate of the drying gas was 6 mL/min; the pressure of the atomized gas was 241 kPa; the circulation time was 400 ms; the shortest residence time was 13.86 ms and the longest residence time was 198.9 ms. The information of the relevant gradient elution program was shown in Table 1 and the information of the relevant parameters for mass spectrometry was shown in Table 2.

TABLE 1
Specific parameters of gradient elution program

| | | Mobile | Mobile | Mobile |
|---|---|---|---|---|
| Time | Flow rate | phase | phase | phase |
| (min) | (mL/min) | A (%) | B (%) | C (%) |
| 0.00 | 0.3 | 100 | 0 | 0 |
| 4.00 | 0.3 | 100 | 0 | 0 |
| 4.01 | 0.3 | 0 | 100 | 0 |
| 8.00 | 0.3 | 0 | 100 | 0 |
| 8.01 | 2.0 | 0 | 0 | 100 |
| 11.00 | 2.0 | 0 | 0 | 100 |
| 11.01 | 3.0 | 100 | 0 | 0 |
| 12.00 | 0.3 | 100 | 0 | 0 |

TABLE 2
Ten-way valve switching program

| | Mobile | Mobile | |
|---|---|---|---|
| Time | phase | phase | Valve |
| (min) | A (%) | B (%) | linkage |
| 0.00 | 80 | 20 | 1 to 2 |
| 4.00 | 80 | 20 | 1 to 10 |
| 6.00 | 70 | 30 | 1 to 2 |
| 10.00 | 50 | 50 | 1 to 2 |
| 10.50 | 5 | 95 | 1 to 2 |
| 11.00 | 5 | 95 | 1 to 2 |
| 11.01 | 80 | 20 | 1 to 2 |
| 12.00 | 80 | 20 | 1 to 2 |

The mass spectrometric system control and data acquisition were performed by using the MassLynx v4.0 software, and the data were automatically processed by a QuanLynx application program. The tandem system was controlled by using the sparkLinkv3.0 software.

### II. Detection Results and Analysis

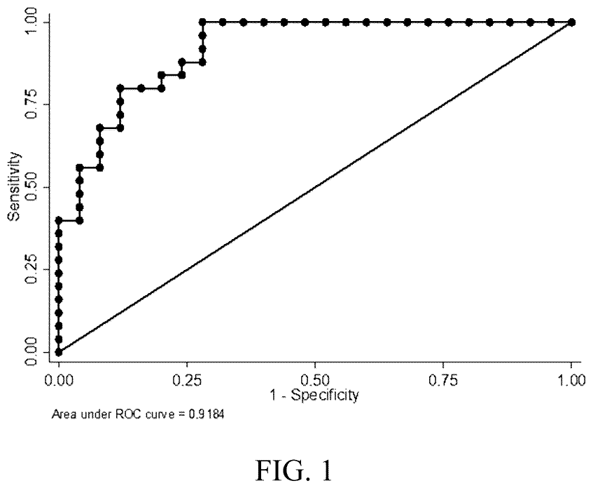

The response values of isopentenyladenine-7-N-glucoside in the blood plasma of the patients with aortic dissection and the control group in a primary ESI and ESI ionization mode are detected in the test. The metabolite profiles in the plasma of the patients with acute aortic dissection are significantly different from those of the control group. Isopentenyladenine-7-N-glucoside has the most significant difference. Isopentenyladenine-7-N-glucoside is significantly elevated in the patient group compared with the control group (Table 3). The result indicates that isopentenyladenine-7-N-glucoside as a metabolic marker is related to acute aortic dissection and can be used for predicting acute aortic dissection. An ROC curve is plotted with the level of isopentenyladenine-7-N-glucoside in the plasma and analyzed. The results show AUC=0.9184 (FIG. 1), indicating a significant advantage for predicting acute aortic dissection.

TABLE 3
Expression levels of isopentenyladenine-7-N-glucoside
in plasma of patients with aortic dissection and control
population detected by mass spectrometry and P value

| | | Acute aortic | |
|---|---|---|---|
| | Control | dissection | |
| | group | group | P value |
| Isopentenyladenine-7-N-glucoside | 36.5 ± 23.3 | 111.3 ± 20.8 | <0.0001 |

It can be known from the results that isopentenyladenine-7-N-glucoside in the plasma can be used as a potential marker for diagnosing acute aortic dissection with excellent diagnosis effect, which meets the convenient, low-trauma and low-cost requirements, and is suitable for the early screening of acute aortic dissection and beneficial to auxiliary diagnosis and treatment evaluation.

1. A method for predicting acute aortic dissection in a patient, the method comprising:
quantitatively detecting isopentenyladenine-7-N-glucoside in a plasma sample from the patient.

2. A reagent for detecting isopentenyladenine-7-N-glucoside in a plasma sample.

3. The reagent for detecting isopentenyladenine-7-N-glucoside according to claim 2, wherein the reagent for detecting isopentenyladenine-7-N-glucoside is a reagent for quantitatively detecting isopentenyladenine-7-N-glucoside.

4. The reagent for detecting isopentenyladenine-7-N-glucoside according to claim 3, wherein the reagent for detecting isopentenyladenine-7-N-glucoside is a reagent for quantitatively detecting isopropenyladienine-7-N-glucoside by online solid phase extraction-liquid chromatography-tandem mass spectrometry.

5. An acute aortic dissection auxiliary diagnostic kit, comprising:
1) a plasma sample treatment reagent; and
2) a reagent for quantitatively detecting isopentenyladenine-7-N-glucoside, comprising an isopentenyladenine-7-N-glucoside standard.

6. The acute aortic dissection auxiliary diagnostic kit according to claim 5, comprising:
1) the plasma sample treatment reagent; and
2) the reagent for quantitatively detecting isopentenyladenine-7-N-glucoside by online solid phase extraction-liquid chromatography-tandem mass spectrometry, comprising the isopentenyladenine-7-N-glucoside standard.

7. The acute aortic dissection auxiliary diagnostic kit according to claim 5, wherein the reagent for quantitatively detecting isopentenyladenine-7-N-glucoside by online solid phase extraction-liquid chromatography-tandem mass spectrometry comprises:
a) an online solid phase extraction reagent, comprising: an HLB SPE column with the specification of 5 μl and 20 mm*3.9 mm; and a mobile phase A: water, a mobile phase B: methanol, and a mobile phase C: acetonitrile; and
b) a liquid chromatography detection reagent comprising: a Poroshell 120 EC-C₁₈ chromatographic column with the specification of 2.7 μl and 2.1 mm*50 mm; and a mobile phase A: 10 mol/L ammonium acetate solution containing 0.1% formic acid, and a mobile phase B: acetonitrile containing 0.1% formic acid.
